(19) United States
(12) Patent Application Publication
(10) Pub. No.: US 2021/0144419 A1
(43) Pub. Date: May 13, 2021

(54) VIDEO INSERTION APPARATUS AND VIDEO DISPLAY TERMINAL APPARATUS

(71) Applicant: SHARP KABUSHIKI KAISHA, Sakai City, Osaka (JP)

(72) Inventors: Hideo NANBA, Sakai City (JP); Hiromichi TOMEBA, Sakai City (JP)

(73) Assignee: Sharp Kabushiki Kaisha, Sakai City, Osaka (JP)

(21) Appl. No.: 17/041,925

(22) PCT Filed: Mar. 7, 2019
(86) PCT No.: PCT/JP2019/009107

§ 371 Date: Sep. 25, 2020

(30) Foreign Application Priority Data
Mar. 30, 2018 (JP) 2018-067287

(51) Int. Cl. H04N 21/234; H04N 21/2343; H04N 21/431; H04N 21/442

(52) U.S. Cl. CPC H04N 21/23424; H04N 21/44218; H04N 21/4316; H04N 21/234363

(57) ABSTRACT

The present invention is to improve the user experience with respect to the fact that, in a case that a viewer watches with a large screen ultra high density display apparatus, most of field of view is covered by the video, and consciousness is focused on the center of the field of view, so the recognition capability for each video information in displaying multiple pieces of video information is reduced. Recognition of multiple pieces of video information is enhanced, by providing multiple pieces of video information and acoustic information according to a display apparatus used by a viewer from a network side device, and reproducing the acoustic information using an audio object along with display of the multiple pieces of video information on the display apparatus side.

### TECHNICAL FIELD

The present invention relates to a video processing apparatus and a video display apparatus.

This application claims priority based on JP 2018-67287 filed on Mar. 30, 2018, the contents of which are incorporated herein by reference.

### BACKGROUND ART

In recent years, the resolution of display apparatuses has been increased and the display apparatuses capable of displaying Ultra High Density (UHD) have been developed. 8K super Hi-Vision broadcast, a television broadcast with about eight thousand pixels in the lateral direction, uses a display apparatus capable of displaying especially high resolution in such UHD displays, and the implementation of the 8K super Hi-Vision broadcast has been in progress. The signal for supplying a video to the display apparatus (8K display apparatus) supporting such 8K super Hi-Vision broadcast has a very wide band, and it is necessary to supply the signal at a speed of higher than 70 Gbps in a case of non-compression, and a speed of approximately 100 Mbps even in a case of compression.

In order to distribute a video signal that uses such a broadband signal, the use of new types of broadcast satellites and optical fibers has been studied (NPL 1).

The ultra high density display apparatus uses a large amount of information that can be provided to a viewer, thus allowing services that provide a wide variety of information to be available. The ultra high density display apparatus has a sufficient number of pixels per unit area even in a case that the screen size is increased, and has sufficient information even in a case that a portion of the display apparatus is used to provide video information, so the user experience of the viewer is greatly improved compared to a case that a similar service is provided for a display apparatus with an existing resolution.

In order to further enhance the presence obtained by increasing the screen size, efforts have been carried out for the acoustic aspect, and the use of an acoustic system using multiple speakers together has been studied (NPL 2).

### CITATION LIST

### Non Patent Literature

NPL 1: Ministry of Internal Affairs and Communications. “About Present State of Promotion of 4K and 8K”. Homepage of Ministry of Internal Affairs and Communications. <www.soumu.go.jp/main_content/000276941.pdf5
NPL 2: Dolby (trade name), “Dolby (trade name) Atmos (trade name) Next-Generation Audio for Cinema”

### SUMMARY OF INVENTION

### Technical Problem

However, in a case that a viewer watches with a large screen ultra high density display apparatus, most of the field of view is covered by the video, and consciousness is focused on the center of the field of view, so the recognition capability for each video information in displaying multiple pieces of video information is reduced.

An aspect of the present invention has been made in view of the above problems, and is to disclose a device and a configuration thereof for enhancing recognition of multiple pieces of video information, by providing multiple pieces of video information and acoustic information according to a display apparatus used by a viewer from a network side device, and reproducing the acoustic information using an audio object along with displaying of the multiple pieces of video information on the display apparatus side.

### Solution to Problem

(1) In order to achieve the object described above, according to an aspect of the present invention, provided is a video insertion apparatus that inserts one or more prescribed videos and one or more pieces of prescribed audio into a stream including a video and a piece of audio and transmits the stream resulting from the insertion to a video display terminal apparatus, the video insertion apparatus including: a scaling processing unit configured to align a size and position of a prescribed video of the one or more prescribed videos to be inserted with sizes and positions of one or more display regions that are part of a display range of the video included in the stream; and an audio object position adjustment unit configured to convert a piece of prescribed audio of the one or more pieces of prescribed audio corresponding to the prescribed video to be inserted into an audio object and configure a position at which the audio object is configured in each of the one or more display regions.

(2) In order to achieve the object described above, according to an aspect of the present invention, provided is the video insertion apparatus, further including: a terminal interface unit configured to acquire terminal information of the video display terminal apparatus, wherein the one or more display regions are configured based on the terminal information.

(3) In order to achieve the object described above, according to an aspect of the present invention, provided is the video insertion apparatus, wherein a plurality of the video display terminal apparatuses to which the stream resulting from the insertion is to be transmitted are grouped based on at least either information about an area or information about a user group, and the prescribed video and the piece of prescribed audio are inserted for each of the plurality of video display terminal apparatuses that are grouped.

(4) In order to achieve the object described above, according to an aspect of the present invention, provided is the video insertion apparatus, wherein in a case that change information is received from a video display terminal apparatus of the plurality of video display terminal apparatuses to which at least one of a plurality of the streams resulting from the insertion is transmitted, the change information being information for the prescribed video and the piece of prescribed audio inserted for each of the plurality of video display terminal apparatuses that are grouped, configurations of the one or more display regions and the audio object of the piece of prescribed audio are changed based on the change information for each of the plurality of video display terminal apparatuses that are grouped.

(5) In order to achieve the object described above, according to an aspect of the present invention, provided is a video display terminal apparatus that receives a stream including information of a video and a piece of audio and reproduces the video and the piece of audio, wherein the video display terminal apparatus transmits, to a video insertion apparatus, information related to a size of a video display unit included in the video display terminal apparatus, and terminal information including information related to a distance between the video display unit and a viewer.

(6) In order to achieve the object described above, according to an aspect of the present invention, provided is the video display terminal apparatus, wherein the information of the size of the video display unit included in the terminal information is normalized to prescribed types of information.

(7) In order to achieve the object described above, according to an aspect of the present invention, provided is the video display terminal apparatus, further including: a user input apparatus, wherein in a case that an operation on a video inserted by the video insertion apparatus is input from the user input apparatus, change information corresponding to the video is transmitted to the video insertion apparatus.

### Advantageous Effects of Invention

According to an aspect of the present invention, recognition of multiple pieces of video information can be enhanced, by providing multiple pieces of video information and acoustic information according to a display apparatus used by a viewer from a network side device, and reproducing the acoustic information using an audio object along with display of the multiple pieces of video information on the display apparatus side.

### BRIEF DESCRIPTION OF DRAWINGS

FIG. 1 is a diagram illustrating an example of a device configuration according to an embodiment of the present invention.

FIG. 2 is a diagram illustrating an example of an audio object.

FIG. 3 is a diagram illustrating an example configuration of a speaker according to an embodiment of the present invention.

FIG. 4 is a diagram illustrating an example of a device configuration according to an embodiment of the present invention.

FIG. 5 is a diagram illustrating an example configuration of a network according to an embodiment of the present invention.

FIG. 6 is a diagram illustrating an example of a device configuration according to an embodiment of the present invention.

FIG. 7 is a diagram illustrating an example of area control and group control according to an embodiment of the present invention.

FIG. 8 is a diagram illustrating an example control of an insertion video and an audio object according to an embodiment of the present invention.

FIG. 9 is a diagram illustrating an example control of an insertion video and an audio object according to an embodiment of the present invention.

FIG. 10 is a diagram illustrating an example of group control according to an embodiment of the present invention.

### DESCRIPTION OF EMBODIMENTS

Hereinafter, a radio communication technology according to an embodiment of the present invention will be described in detail with reference to the drawings.

### First Embodiment

An embodiment of the present invention will be described in detail below by using the drawings. FIG. 1 illustrates an example of a device configuration according to the present embodiment. The present embodiment includes a video server 101, a video insertion apparatus 102, a video display terminal apparatus 103, and a terminal information management apparatus 104, and the video insertion apparatus 102 and the video display terminal apparatus 103 are connected through a network 128. This network 128 may use various forms of networks, such as a wired network using copper cables or optical fiber cables, a public wireless network such as a cellular wireless network, and a private wireless network such as a wireless LAN. In the present embodiment, a cellular wireless communication network is assumed to be used.

The video server 101 includes a video combining unit 105 configured to supply a video stream, an audio combining unit 106 configured to generate an audio stream, and a multiplexing unit 107 configured to multiplex the video stream and the audio stream. The audio stream may include two or more pieces of audio data. The audio stream encoding method is not particularly specified, but MPEG AAC, MPEG SAOC, or the like may be used. The video stream encoding method is not particularly specified, but H.264 scheme, H.265 scheme, VP9, or the like may be used. The method for multiplexing the audio stream and the video stream is not particularly limited, but MPEG2 Systems, MPEG Media Transport (MMT), MP4, or the like may be used. A stream obtained by multiplexing the audio stream and the video stream is hereinafter referred to as a composite stream.

The video insertion apparatus 102 is located between the video server 101 and the network 128, and inserts, to the composite stream output from the video server 101, another video stream in which the video size is controlled and another audio stream including an object audio in which the audio position is controlled. 108 is a demultiplexer unit configured to demultiplex the input composite stream to extract the video stream and the audio stream, and 109 is a video combining unit configured to compose video data of an video stream for insertion output from a stream cache unit 121 with the video data included in the video stream output from the demultiplexer unit 108. The method for composing video streams is not particularly specified. The video stream output from the demultiplexer unit 108 may be decoded to generate raw video data, and the video stream output from the stream cache unit 121 may be decoded to generate raw video data, and the two pieces of video data may be composed and then reencoded to obtain a composed video stream, or the video stream output from the demultiplexer unit 108 and the video stream output from the stream cache unit 121 may be composed on a coding unit basis such that the reencoding process is partially decreased. The method may be a method that allows the video stream output from the stream cache unit 121 to be composed as another track. 110 is an audio combining unit configured to compose the audio stream output from the stream cache unit 121 with the audio stream output from the demultiplexer unit 108. Although the method for composing audio streams is not particularly specified, for example, in a case that the audio stream output from the demultiplexer unit 108 is a channel based audio source, the audio stream may be composed as an object audio source obtained by using the channel based audio source as bed and adding the audio object output from the stream cache 121. In a case that the audio stream output from the demultiplexer unit 108 is the object audio source, an audio object may be added to the object audio source. At this time, it may be downmixed in a case that the upper limit of the number of audio objects is exceeded. The audio stream to be composed may also be composed as another track. 111 is a multiplexer unit that multiplexes the composed video stream output from the video combining unit 109 and the composed audio stream output from the audio combining unit 110. The re-multiplexed composite stream is output to the network 128.

121 is the stream cache unit configured to send, according to the control of an insertion stream configuration unit 113, the video stream for insertion output from a scaler/position adjustment unit 114 and the audio stream for insertion output from an audio object position adjustment unit 117 to the video combining unit 109 and the audio combining unit 110, respectively. According to the control of the insertion stream configuration unit, the video stream and the audio stream are accumulated, and the accumulated video stream and audio stream are sent to the video combining unit 109 and the audio combining unit 110, respectively. 114 is the scaler/position adjustment unit which is a block configured to perform scaling processing on the video data output from a video selection unit 115 and generate a video stream in which display position has been adjusted according to the control of the insertion stream configuration unit 113. 115 is a block configured to transmit video data selected from a video library unit 116 to the scaler/position adjustment unit 114 according to the control of the insertion stream configuration unit 113. 116 is the video library unit configured to accumulate multiple pieces of video data for insertion. 117 is the audio object position adjustment unit configured to convert the audio data output from the audio selection unit 118 to an audio object by the control of the insertion stream configuration unit 113, and output an audio stream in which the position of the audio object is configured. 118 is the audio selection unit configured to output the audio data selected from an audio library 119 according to the control of the insertion stream configuration unit 113. 119 is the audio library configured to accumulate multiple pieces of audio data for insertion. 120 is a library update unit which is a block configured to update the contents of the video library 116 and the audio library 119 from outside the video insertion apparatus 102, and transmit the updated content to the insertion video stream configuration unit 113.

112 is a terminal interface unit configured to communicate with the video display terminal apparatus 103 to be connected via the network 128, obtain various pieces of information such as terminal capability information related to the hardware or the software of the video display terminal apparatus 103, and user operation information input via a user input apparatus 127 of the video display terminal apparatus 103, obtain terminal registration information, related to the video display terminal apparatus 103, that is registered in advance by communicating with the terminal information management apparatus 104, and transmit these pieces of information to the insertion video stream configuration unit 113. The insertion video stream configuration unit 113 is a block configured to configure the display size and display position of the video stream selected from the video library 116, and a parameter for converting the audio stream selected from the audio library 119 to an audio object, based on information of the video display terminal apparatus 103 obtained from the terminal interface 112, user operation information, information obtained from the library update unit 120, other information obtained from the video server 101, and the like.

Next, an example configuration of the video display terminal apparatus 103 will be described. 122 is a demultiplexer unit configured to perform demultiplexing processing on the input composite stream, and output the video stream and the audio stream, 123 is a video display unit configured to decode and display the video stream and display the picture for the user interface provided by a network service interface unit 125, 124 is an audio reproduction unit configured to decode the audio stream to perform multi-channel reproduction, and reproduce audio for the user interface provided by the network service interface unit 125, and 125 is a network service interface unit configured to communicate with the terminal interface unit 112 of the video insertion apparatus 102 via the network 128, and exchange various types of information such as information of a terminal information unit 126 and information of the user input apparatus 127. 126 is the terminal information unit which is a block configured to store information related to the video display terminal apparatus 103 such as information specific to the configuration of the video display terminal apparatus 103, unique information for individually identifying the video display terminal apparatus 103, information for identifying a contract for using the network 128, and the like, and transmit information stored to the terminal interface unit 112 of the video insertion apparatus 102 via the network service interface unit 125. 127 is the user input apparatus which is a block configured to receive user operations for the video display terminal apparatus 103, transfer the user operation information to the terminal interface unit 112 of the video insertion apparatus 102 via the network service interface unit 125, generate a video for the user interface to output the video to the video display unit 123, and generate an audio for the user interface to output the audio to the audio reproduction unit 124.

The terminal information management apparatus 104 is an apparatus configured to receive an inquiry from the terminal interface unit 112 of the video insertion apparatus 102, and transmit information related to services that can be used by the video insertion apparatus 102 as a response, based on information related to the video display terminal apparatus 103 included in the inquiry.

The audio reproduction unit 124 included in the video display terminal apparatus 103 is configured to be capable of reproducing the object audio. Unlike existing channel based audio sources, the object audio is a scheme that defines each of multiple audio sources constituting the reproduction audio as an audio object (virtual audio source) and arranges and reproduces the audio sources at a free position of the reproduction space. Existing channel based audio sources are audio sources that are prepared with the assumption that speakers are arranged in multiple predetermined directions, for example left and right two directions in a case of a two channel stereo audio source, or a left front, a front center, a right front, a right rear, and a left rear in a case of a five channel surround audio source. In many cases, speakers used for channel based audio sources are located on a horizontal plane, and in some implementations, multiple horizontal planes are provided to reproduce sound traveling from an upper side in a predetermined direction. In such channel based audio sources, since multiple audio sources are mixed for the assumed speaker arrangement at the time of audio source regeneration, there is a problem that an intended sound may fail to be reproduced in mixing the audio sources, due to differences of positions at which the speakers are arranged in the reproduction environment or a difference of the position of the listener at the time of reproduction. This may be expressed as a narrow sweet spot of the audio source. In contrast, in a case that an object audio is used, selection of speakers to reproduce a virtual audio source and mixing can be adaptively performed depending on the speaker arrangement positions or the listener position, thus allowing an intended sound field to be reproduced in generating the audio source even in a case that the reproduction environment changes. The selection of speakers to reproduce an audio object and mixing may be referred to as sound rendering.

Although there are multiple methods for defining a virtual audio source, it is often the case that multiple audio sources located at relative positions from one reference point are used. In the present embodiment, the virtual audio is defined as the audio source represented by the polar coordinates denoted by r, θ, and ϕ from the reference position (origin) as illustrated by 201 in FIG. 2. As a result, it is possible to configure the virtual audio source at any position such as the front 3 m, the right 1 m, and the upper 2 m in the front of the viewing position. The reproduction environment for object reduction is not specifically defined, but in a case that the display terminal apparatus 301 is located in front of the viewing position 302 as illustrated in FIG. 3 as an example, the main speakers 301-1 and 301-2 are arranged on the left and right sides of the video display terminal apparatus 301, the top speakers 304-1 and 304-2 are arranged above the main speakers, and the satellite speakers 305-1 to 305-4 including vertically-long speaker arrays are arranged from left to rear and right to rear of the viewing position 301. In a case that an audio object is configured not only on a horizontal plane but also on an upper side, an audio object at a position configured by performing sound rendering can be represented by using not only the main speakers 303-1 and 303-2 but also the top speakers 304-1 and 304-2 and/or speakers arranged in upper part of the speakers constituting the satellite speakers 305-1 to 305-4. The audio reproduction unit of the video terminal apparatus 301 learns the arrangement positions of the main speakers 303-1 and 303-2, the top speakers 304-1 and 304-2, the satellite speakers 305-1 to 305-4 (hereinafter referred to as a speaker group) by using a method in which a calibration microphone is installed at the viewing position 302 or a prescribed position, and calibration reference signals reproduced from the speaker group are collected by the calibration microphone, thereby the transfer function from each speaker constituting the speaker group to the viewing position can be determined and used as information related to the arrangement positions. The audio reproduction unit of the video terminal apparatus 301 can perform the sound rendering by using the transfer function in reproducing the object audio. The configuration of the speakers is not limited to that illustrated in FIG. 3, and the number and positions of the speakers to be arranged may vary. The sound rendering needs to be performed in accordance with the number and positions of the speakers to be arranged.

Next, the insertion of the video and the audio will be described with reference to FIG. 8. The video display terminal apparatus 103 notifies the terminal interface 112 of the video insertion apparatus 102 of information related to the size and viewing distance of the video display unit 123 of the video display terminal apparatus 103 via the network 128. In FIG. 8, 801 corresponds to the video display unit 123, and may transmit the vertical size 807 and the horizontal size 806 as the size of the video display unit. The diagonal length 805 of the screen and the aspect ratio of the screen may also be transmitted. The distance 808 between the video display unit 123 and the viewer 804 corresponds to the viewing distance. The viewing distance to be used may be a value measured by a sensor such as a camera provided in the video display terminal apparatus 103, or may be a viewing distance configured in advance depending on the size of the video display unit 123. The size of the video display unit 123 and the viewing distance configured in advance may have a proportional relationship. As an example, a value approximately 3 to 5 times the vertical size of the video display unit 123 may be used as the viewing distance configured in advance. The size of the video display unit 123 may be normalized into some types of size to reduce the amount of information related to the size of the video display unit 123. For example, the diagonal length of the video display unit 123 may be normalized to a size of 25 inches or less, 32 inches or less, 40 inches or less, 50 inches or less, 70 inches or less, 100 inches or less, 150 inches or less, or larger than 150 inches. Similarly, the viewing distance may also be normalized. By normalizing the size of the video display unit 123, the types of the video streams and the audio streams to be inserted in the video insertion apparatus 102 are limited, and it is easy to generate a video stream or an audio stream in advance.

The video insertion apparatus 102 that obtains the information related to the size and the viewing distance of the video display unit 123 of the video display terminal 103 selects video data and audio data to be inserted by the insertion video stream configuration unit 113 from the video library 118 and the audio library 119 via the video selection unit 115 and the audio selection unit 118, respectively. The scaling processing and display position adjustment are performed, on the selected video data, by the scaler/position adjustment unit 114 so as to allow overlapping display composition to be performed on the video stream included in the composite stream received from the video server 101. The scaler/position adjustment unit 114 converts the video data obtained by performing the scaling processing and the display position adjustment into a video stream and transmits the video stream to the stream cache unit 121. The selected audio data is converted to an audio object and the position of the audio object is configured by the audio object position adjustment unit 117. The position of the audio object is described with reference to FIG. 8. Assuming that the insertion video is displayed in the region indicated by 802, and that the head of the viewer 804 is located in the center front of the display screen 801, the position of the audio object is configured in the space indicated by the region 803 on the front surface of the video display unit 123. After configuring the position of the audio object, the audio object position adjustment unit converts the configured audio object into an audio stream and transmits the audio stream to the stream cache unit 112. The stream cache unit 112 transmits the video stream for composition to the video combining unit 109 and the audio stream for composition to the audio combining unit 110. In a case that video streams and/or audio streams corresponding to videos to be inserted are accumulated in the stream cache unit 121, the insertion video stream configuration unit 113 may control the stream cache unit 121 such that the video stream and/or the audio stream accumulated in the stream cache unit 112 are used as an insertion video without using the data in the video library unit 116 and the audio library 119. The video combining unit 109 composes the video streams such that the video stream output from the stream cache unit overlaps the video stream transmitted from the video server 101. Although the composing method is not particularly specified, the video stream transmitted from the video server and the stream transmitted from the stream cache unit may be decoded once and composed to be video data and then reencoded as a composed video stream, or may be composed as a video of another track. The audio combining unit 110 composes the audio stream output from the stream cache unit 121 with the audio stream transmitted from the video server. In a case that there is a margin in the number of audio objects, the audio objects are composed in an manner of adding a new audio object, and in a case that it is not possible to add a new audio object without any processing due to a limitation on the number of audio objects, down-mix processing is performed on the audio objects included in the audio streams transmitted from the video server, and then the audio objects included in the audio streams output from the stream cache unit 121 are added for composition. The video streams and the audio streams with which the video streams and the audio streams output from the stream cache unit 121 are composed are multiplexed in multiplexing processing by the multiplexer unit 111 and are transmitted to the video terminal apparatus 103 via the network 128 as a composed stream, and the video is reproduced in the region 802 illustrated in FIG. 8 and the audio for which the audio object is configured at the position of the region 803 is reproduced. Note that one or multiple pieces of video/audio may be inserted. In a case that multiple pieces of video/audio are inserted, the size of the videos to be inserted may vary. The video and audio may be inserted at all times, or the On/Off state of the insertion may be switched according to external information, such as the contents of the composite stream transmitted from the video server, the timing of the update of the library, or the like.

In a case that the size of the display apparatus 123 of the video display terminal 103 is small and an audio object configured in the region for displaying the insertion video is not so effective in arousing attention to the insertion video, an audio object of the video to be inserted outside the range of the display apparatus 123 may be configured. As an example, FIG. 8 illustrates an example configuration of a position of an audio object in a region 813 outside the display area 811 of the display apparatus 123. In a case that the size of the display apparatus 123, or the vertical size 817 and the horizontal size 816 here are smaller than prescribed values, the position of the audio object may be configured in the region 813 instead of the position in the region 812 of the video to be inserted. The side view is illustrated in FIG. 9. An example of a case that the display apparatus 123 is large is illustrated in FIG. 9(a), and an example of a case that the display apparatus 123 is small is illustrated in FIG. 9(b). 901 and 908 are viewers, 902 and 909 are display apparatuses, 903 and 910 are videos to be inserted. and 904 and 911 are audio objects to be configured. In a case that the size 905 of the display apparatus 902 is large, the insertion video 903 is sufficiently at an upper position with respect to the direction of the line of sight 907 of the viewer, and the audio object 904 configured at the position of the insertion video 903 allows the sound to travel from outside of the direction of the line of sight 907, the audio object 904 may be configured near the position where the insertion video 903 is displayed. In a case that the size 912 of the display apparatus 909 is small, the position of the insertion video 190 is not sufficiently at an upper position with respect to the direction of the line of sight 914, and the audio object configured at the position of the insertion video 910 does not allow the sound to travel from outside of the direction of the line of sight 914, the audio object 911 may be configured above the display apparatus 909. Because the relative position of the audio object with respect to the line of sight also relates to the viewing distance 906 or 912, the position of the audio object may be configured in consideration of the viewing distance 906 or 913, as well as the size 905 or 912 of the display apparatus 902 or 909.

An example of a configuration has been described above in which the insertion video and the insertion audio are composed by the video insertion apparatus separated from the video display terminal apparatus by the network, but a configuration may be adopted in which the insertion video and the insertion audio are composed by the video display terminal apparatus. An example of such a configuration is illustrated in FIG. 4. The same numbers are used for the same function as in FIG. 1, and the description is omitted below. The video insertion apparatus 401 does not perform the composition on the video stream and the audio stream, but the insertion video is treated as another service or program for multiplexing. The video stream and the audio stream output from the stream cache 121 are multiplexed by the multiplexing unit 404 to form a composite stream, and the composite stream transmitted from the video server 101 and the composite stream output from the multiplexing unit 404 are multiplexed by the multiplexer unit 405 as multiple services or programs, and transmitted to the video display terminal apparatus 404 via the network 128. In the video display terminal apparatus 403, the composite stream received as the multiple services or programs are separated into individual services or programs by the demultiplexer unit 406, the services or programs transmitted from the video stream are separated into video streams and audio streams by the demultiplexer unit 407, the services or programs of the insertion video are separated into video streams and audio streams by the demultiplexer unit 408, the video streams are composed by the video combining unit 409, and the resultant video is displayed by the video display unit 123. The audio streams are composed by the audio combining unit 410 and reproduced by the audio reproduction unit 124. The terminal information unit 411 transmits, to the terminal interface unit 112 of the video insertion apparatus 401 via the network service interface unit 125, information for indicating that the insertion video stream can be composed in the video display terminal apparatus, in addition to the information related to the size and the viewing distance of the display apparatus 123 of the video display terminal apparatus 403. Such a configuration allows the operation illustrated in the configuration illustrated in FIG. 1.

As illustrated above, the audio object is configured to be at a position near the display position of the video inserted in the video insertion apparatus or at a position where it is possible to recognize that the insertion video is displayed and the audio is reproduced, so that the attention of the viewer is aroused and it is possible to inform that the video is inserted. Configuring the audio object such that the sound travels from the displayed insertion video improves the user experience of the insertion video.

### Second Embodiment

In the present embodiment, a configuration will be described in which the network can be divided into multiple sub-networks, for example, networks provided in specific regions, video insertion apparatuses are located in the divided networks to allow insertion of a video effective only in the divided networks, or allow insertion of a video effective only in groups based on information of users connected to the networks. FIG. 5 illustrates an example of a configuration of a cellular wireless network. A gateway 501 is located between a core NW 506 that constitutes the cellular network and the Internet 502, and exchanges data between the Internet 502 and the core NW. The core NW 506 includes a core network 1 507 and a core network 2 508 each corresponding to a subnet, and connects to the core network 1 507 and the core network 2 508 via a gateway unit 504 and a gateway unit 505, respectively. The core network 506 includes a video insertion apparatus 515, and the video insertion apparatus 515 is connected to a library network 503 for rewriting the video library and the audio library for insertion, and the data of the video library and the audio library can be rewritten via the network. The core network 1 507 includes multiple base station apparatuses 509 and 510, and further includes a video insertion apparatus 511. The core network 2 508 includes multiple base station apparatuses 512 and 513, and further includes a video insertion apparatus 514. The core networks corresponding to the sub-networks may be networks that provide communication services for certain regions, and may be, for example, sub-networks that provide communication services for certain local municipalities, certain buildings, certain competition fields, or the like, for example. The video insertion apparatus 515, 511, and 514 may share all or a portion of the data of the video library and the audio library. The method for sharing the data is not particularly specified. A general method for sharing distributed cache, such as management based on hash values, may be used. Hereinafter, a description is provided using a cellular network as an example, but the present invention can be implemented not only in the cellular network but also in other forms of networks, such as a local area network (LAN) using Ethernet (trade name) or the like, and a wireless LAN.

The configuration of the device used in the present embodiment is illustrated in FIG. 6. The basic configuration is the same as the configuration of the device illustrated in FIG. 1, so the same reference numerals are assigned to the blocks that perform the same operations, and the following descriptions are omitted. The video server 101 may be connected to the Internet, or may be connected to any network within the core network. The video insertion apparatus 604 has substantially the same configuration as the video insertion apparatus 102 illustrated in FIG. 1, but a terminal interface unit 603 further connects to a group management apparatus 602, performs grouping using the terminal information of the video display terminal apparatus to be connected, and performs control of the video and the audio to be inserted on a group unit basis. The video insertion apparatus 604 connected to the core network corresponding to a sub-network performs the control of the video and the audio to be inserted, depending on whether the video display terminal apparatus to be connected is a connection from within the core network corresponding to a sub-network. The video display terminal apparatus 601 includes a network service interface unit 605 that provides a grouping based user interface.

An example of area control and group control will be described using FIG. 7. In this example, there is a core network 1 701 and a core network 2 711 corresponding to sub-networks, and the core network 1 701 includes a base station apparatus 702, and a video display terminal apparatus 703 and a video display terminal apparatus 704 are connected to the base station apparatus 702. The core network 2 711 includes a base station apparatus 712, and a video display terminal apparatus 713 and a video display terminal apparatus 714 are connected to the base station apparatus 712. Each of the core network 1 701 and the core network 2 711 includes a video insertion apparatus and manages the base station apparatus, and can configure the video and the audio to be inserted individually for the video display terminal apparatuses connected to the base station apparatus.

FIG. 7 illustrates an example in which the first insertion video is an insertion video to be displayed on the all video display terminals, the second insertion video is an insertion video for only the video terminal apparatus 703, the third insertion video is an insertion video to be inserted for a group into which the video display terminal apparatus 704 and the video display terminal apparatus 713 are grouped, and the fourth insertion video is an insertion video to be displayed on the video terminal apparatuses connected to the core network 2 711. In this way, the first video 705 and the second video 706 are displayed on the video display terminal apparatus 703, and the audio objects for the audio streams corresponding to the respective videos are configured at the positions of 705 and 706. The first video 707 and the third video 708 are displayed on the video terminal apparatus 704, and audio objects for the audio streams corresponding to the respective videos are configured at the positions of 707 and 708. The first video 715, the third video 716, and the fourth video 717 are displayed on the video display terminal apparatus 713, and the audio objects for the audio streams corresponding to the respective videos are configured at the positions of 715, 716, and 717. The first video 718 and the fourth video 719 are displayed on the video display terminal apparatus 714, and the audio objects of the audio streams corresponding to the respective videos are configured at the positions of 718 and 719. The operation described above enables area control and group control of the videos and the audios to be inserted, thus making it possible to effectively provide information unique for each user and for each area, and the user experience is improved. By registering, in advance, information related to the videos to be inserted in the video insertion apparatus 604, or in the terminal information management apparatus 104 or the group management apparatus 602 via the video insertion apparatus 604, the videos and the audios related to the user's interests may be inserted. The videos and audios to be inserted are not limited to the videos and audios that are accumulated in the video library 116 and the audio library 119 in advance, but a video using a composite stream transmitted from the video server 101, an audio based video, or other information such as an audio or the like, as an example, a video and audio may be inserted that is obtained by processing a portion of a video and audio included in a composite stream and highlighting a video and audio of a specific person, structure, and the like included in the composite stream.

For the insertion video being grouped, the user may access the video insertion apparatus 604 via the network service interface 603 by using the user input apparatus 127 to change the insertion method of the insertion video and the insertion audio. An example of this operation is described using FIG. 10. It is assumed that a video display terminal apparatus 1002 and a video display terminal apparatus 1003 connected to a base station apparatus 1001 are grouped, and a first insertion video and a second insertion video are shared within the group. It is assumed that in the video display terminal apparatus 1002, the first video is displayed in the region 1004, and the second video is displayed in the region 1005, and in the video display terminal apparatus 1003, the first video is displayed in the region 1006, and the second video is displayed in the region 1007, and one audio object is configured in each region to reproduce an audio corresponding to the video. This state is illustrated in FIG. 10(a). In this state, the user of the video display terminal apparatus 1002 operates the user input apparatus to change the size of the display region of the second video displayed in the region 1006 to the size indicated by the region 1008. This change information is transmitted to the video insertion apparatus via the network service interface 603 in the video display terminal apparatus 1002, and causes the configuration of the video and audio to be inserted for the video display terminal apparatus 1002 and the video display terminal apparatus 1003 to be changed. An example of the display of the insertion video and the audio object after the change is illustrated in FIG. 10(b). The display regions of the second video displayed in the video display terminal apparatus 1002 and the video display terminal apparatus 1003 are changed to 1009 and 1010, respectively. The number of audio objects for the second video is increased to two, and the audio objects are configured to be located at both ends of the display regions 1009 and 1010. This effectively informs the user that the insertion video is a video that has been manipulated by the user, thus improving the user experience.

### Common in All Embodiments

A program running on an apparatus according to the present invention may serve as a program that controls a Central Processing Unit (CPU) and the like to cause a computer to operate in such a manner as to realize the functions of the above-described embodiment according to the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiment according to the present invention may be recorded in a computer-readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. The “computer-readable recording medium” may be any of a semiconductor recording medium, an optical recording medium, a magnetic recording medium, a medium dynamically retaining the program for a short time, or any other computer readable recording medium.

Each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. In a case that with advances in semiconductor technology, a circuit integration technology appears that replaces the present integrated circuits, one or more aspects of the present invention can use a new integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. A configuration in which constituent elements, described in the respective embodiments and having mutually the same effects, are substituted for one another is also included in the technical scope of the present invention.

### INDUSTRIAL APPLICABILITY

The present invention can be used in a video insertion apparatus and a video display terminal apparatus.

1. A video insertion apparatus that inserts one or more prescribed video and one or more pieces of prescribed audio into a stream including a video and a piece of audio and transmits the stream resulting from the insertion to a video display terminal apparatus, the video insertion apparatus comprising:
a scaling processing unit configured to align a size and position of a prescribed video of the one or more prescribed videos to be inserted with sizes and positions of one or more display regions that are part of a display range of the video included in the stream; and
an audio object position adjustment unit configured to convert a piece of prescribed audio of the one or more pieces of prescribed audio corresponding to the prescribed video to be inserted into an audio object and configure a position at which the audio object is configured in each of the one or more display regions.

2. The video insertion apparatus according to claim 1, further comprising:
a terminal interface unit configured to acquire terminal information of the video display terminal apparatus, wherein
the one or more display regions are configured based on the terminal information.

3. The video insertion apparatus according to claim 1, wherein
a plurality of the video display terminal apparatuses to which the stream resulting from the insertion is to be transmitted are grouped based on at least either information about an area or information about a user group, and the prescribed video and the piece of prescribed audio are inserted for each of the plurality of video display terminal apparatuses that are grouped.

4. The video insertion apparatus according to claim 3, wherein
in a case that change information is received from a video display terminal apparatus of the plurality of video display terminal apparatuses to which at least one of a plurality of the streams resulting from the insertion is transmitted, the change information being information for the prescribed video and the piece of prescribed audio inserted for each of the plurality of video display terminal apparatuses that are grouped, configurations of the one or more display regions and the audio object of the piece of prescribed audio are changed based on the change information for each of the plurality of video display terminal apparatuses that are grouped.

5. A video display terminal apparatus that receives a stream including information of a video and a piece of audio and reproduces the video and the piece of audio, wherein
the video display terminal apparatus transmits, to a video insertion apparatus,
information related to a size of a video display unit included in the video display terminal apparatus, and
terminal information including information related to a distance between the video display unit and a viewer.

6. The video display terminal apparatus according to claim 5, wherein
the information of the size of the video display unit included in the terminal information is normalized to prescribed types of information.

7. The video display terminal apparatus according to claim 5, further comprising:
a user input apparatus, wherein
in a case that an operation on a video inserted by the video insertion apparatus is input from the user input apparatus, change information corresponding to the video is transmitted to the video insertion apparatus.
